(19) United States
(12) Patent Application Publication
(10) Pub. No.: US 2008/0028960 A1
(43) Pub. Date: Feb. 7, 2008

(54) METHOD AND DEVICE FOR PRINTING BOARD-SHAPED WORK PIECES

(75) Inventors: Norbert Damm, Karlsdorf-Neuthard (DE); Michael Poitinger, Baiersbronn (DE); Sascha Lammle, Oberndorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 11/691,663

(22) Filed: Mar. 27, 2007

(30) Foreign Application Priority Data
Apr. 8, 2006 (DE) 102006016694.9

(51) Int. Cl. B41F 5/02

(52) U.S. Cl. 101/231; 101/484

(57) ABSTRACT

A method and a device for printing board-shaped work pieces in a printing gap are provided. The printing gap is formed by two printing rollers that are adjustably spaced apart from each other, with the board-shaped work piece being transported on a transporting device to the printing gap and being printed when passing through the printing gap. Prior to or during the transport to the printing gap, a thickness of each work piece is measured and the printing gap is adjusted prior to the printing process via a parallel or offset change of the distance between the two printing rollers in reference to each other, according to the measured thickness of the work piece.

### CROSS-REFERENCE TO RELATED APPLICATIONS

This application claims the benefit of German priority application No. DE 10 2006 016 694.9, filed Apr. 8, 2006, which is incorporated herein by reference as if fully set forth.

### BACKGROUND

The invention relates to a method and a device for printing board-shaped work pieces. The work pieces are printed in a printing gap, formed between two printing rollers with their distance in reference to each other being adjustable. For this purpose, the board-shaped work pieces are transported to the printing gap via a transportation device. The printing rollers forming the printing gap can be printing cylinders for direct printing, application rollers for indirect printing, or counter-pressure cylinders.

Such printing methods and respective devices have been known for a long time. Recently, using such a printing method, increasingly printed images of decors and grids are applied to wood composition boards (particle boards) and the like in order to give them the image of real wood. This is not only more cost-effective in reference to real wood veneer but also to foil coatings of wood composition boards that have been used for quite some time.

For a quality of appearance as high as possible a simple one-color print is insufficient, though. Rather it is desired to apply the grain or the decors in a multi-colored print onto the board-shaped work piece. This is not only the case in wood composition material; applications onto other materials, which can be improved in their quality by surface printing, such as for example stone or synthetic leather, or also plastic parts, can also be optically improved by a multi-colored print.

Particularly for high-quality, multi-color prints it is mandatory, though, that the printed image is positioned on the work piece within very narrow tolerances, typically with tolerances ranging approximately from ±0.1 mm to ±0.25 mm. Only in this way can an optic quality of the printed surface be achieved comparable to the conventional foil coating.

However, these requirements are much more difficult to be fulfilled by the presently processed board-shaped work pieces compared to conventional printing machines for paper or foils. Due to the fact that the work pieces do not travel endlessly through the printing machine and a printing according to the example of paper sheet printing machines is generally impossible due to the lack of elasticity of the respective board-shaped work pieces. Simultaneously, particularly board-shaped work pieces that are to be printed with wood grain or wood decors have dimensions up to several square meters, without this changing the tolerance to be adhered to. The requirements for a precise alignment of the printing rollers operating and their production tolerances are therefore extremely high and are hard to be pre-adjusted in practice.

Further complicating this is the fact that the printing rollers forming the printing gap in printing machines of prior art can be adjusted in their distance in reference to each other, in order to allow the printing of board-shaped work pieces of different thicknesses. Here, again, quite different conditions are given than for the printing of paper sheets and paper webs or foils. The mutual adjustment of the printing rollers can hardly be achieved with the necessary parallel alignment, which ensures the desired accuracy in the print in large work pieces and thus respectively long printing rollers. Printing rollers being offset in height, i.e. an unparallel condition of the level stretched by the axes of the printing rollers, develop during the printing by the elasticity of the printing roller rolling over the surface of the work piece over an effective radius not being constant in its width. In indirect printing and other commonly used printing rollers, a change of the effective radius of the printing roller by only 0.1 mm leads to a longitudinal change of the printed image by approximately 0.6 mm per running length of the printing roller. This would be far outside the printing tolerances desired and/or necessary for a high-value, multi-color print.

The parallel alignment of the printing rollers must therefore be manually readjusted. For this purpose a piece of paper is inserted into the printing gap, if necessary with a board positioned therein, and is moved back and forth in the printing gap. An experienced print master can then sense via the manually guided piece of paper if the printing gap is or is not parallel over the entire width. This measurement performed by intuition and the respective fine-tuning yields beneficial results in the tenth or hundredth of a millimeter range.

However, particularly in large-surface, board-shaped work pieces, it is observed that the multi-color print appears blurred and sometimes the boards even become even rotated about the vertical axis when passing through the printing gap.

### SUMMARY

The present invention is therefore based on the objective of providing a method and a device of the type mentioned at the outset, which allows a user to print board-shaped work pieces with improved printing tolerances for images printed.

This object is attained by use of the method as well as the device of the invention.

Preferred embodiments of the method and device are described in detail below.

According to the invention, when analyzing the problem of blurred prints and/or too large printing image tolerances detected in spite of a precise manual alignment of the printing roller it has been found that the primary problem lies in the thickness tolerance of the board-shaped work pieces. In particular, large wooden material boards have usually a slightly wedge-shaped cross-section, which is equivalent to an offset height alignment of the printing roller. Because the thicker side of the wooden material board leads in parallel printing rollers to a reduction of the effective radius of the printing roller in reference to the thinner side of the work piece, which may amount to as much as 0.1 to 0.2 mm. As already mentioned, this causes a change in the length of the printed image per running length of the printing roller by approximately 0.65 to 1.3 mm. Even a slight waviness or wedge-shape of the work piece in the longitudinal direction influences the printing quality and the tolerances of the printed image by a respectively higher or lower compression height, which, on the one side, results in compression forces being too high and, on the other side, results in compression forces being too low leaving weak or blurred printed images.

Based on this knowledge, according to the invention the thickness of each work piece is measured in front of the printing gap, if necessary including the conveyer belt and of its elastic thickness subject to tolerances, when present, and the printing rollers forming the printing gap are automatically adjusted by way of adjustment motors at their bearings to the measured thickness of the work piece, if necessary including the conveyer belt. When different thicknesses are measured over the width of the work piece, for example a wedge shape, the printing gap is adjusted respectively by offsetting the two printing rollers in reference to each other, i.e. by changing the distance of the two printing rollers to each other at an angle, adjusted to said wedge shape so that the effective radius of the printing roller remains constant over the entire width of the work piece and thus the desired minimal tolerance values of the image can be achieved.

The general principle of the present invention is therefore a mutually independent motorized printing gap adjustment, provided at both sides, which is dependent on a work piece thickness signal that is measured upstream.

For practical purposes, the thickness of the work piece is measured at least at two measuring points, with their connecting line essentially extending parallel to the axes of the printing rollers. This way a correlation of the thickness of the work piece, that can be realized very easily, is achieved in reference to the adjustment of the printing gap, in particular for minimally wedge-shaped boards.

The measurement of thickness can occur over the entire length of the work piece in a travel direction so that a thickness profile is measured, according to which the printing gap can be adjusted in real time during the passing of the work piece. This measure allows, independent from a change of thickness of the work piece, to adjust the printing gap over its width in case of changes in thickness of the work piece over its length. It is ideal, of course, when both the thickness tolerances in the width as well as the one in the length of the work piece can be compensated by respectively adjusting the printing gap in order to apply a precise print onto the surface of the board.

Particular advantages also result within the scope of the present invention when the adjustment of the printing gap is not only performed according to the thickness measurement performed prior to printing but also by the pressure of the printing rollers and thus the forces measured acting upon their bearings. Because a measured difference of the bearing forces provides an indication that either the surfaces of the printing rollers are not parallel or a height offset being present, or that the just printed work piece has no parallel surfaces. In either case, then the adjustment motors provided at the bearings of the rollers are operated until the difference of the bearing forces approximately approaches zero or are equivalent to the respectively desired offset value.

Alternatively or additionally to the direct or indirect addressing of the adjustment motors based on the measured difference in bearing forces, such a control can also be used to correct the correlation between the thickness measured prior to printing and the adjustment of the printing gap. For example, it may be possible that by a slightly offset height of the two printing rollers an undesired parallel off-set develops, which cannot be corrected by an adjustment of the printing gap based on the thickness measurement of the work piece. Here, the measured difference of the bearing forces can generate a correcting adjustment.

The conditions of printing machines of the present type are complex, though, and an adjustment of the printing gap in real time as a feed-back to respective measurements generates an oscillating system so that it may be advantageous to average the bearing forces and their difference in temporal intervals and then to perform a correction of the trend calculated by a suitable algorithm. A difference of measured bearing forces then does not immediately effect the just measured work piece but leads to an increasingly improving result over several work pieces.

When not only the differential value of the two bearing forces is measured but also its absolute value, feed-back can be learned from the thickness profile in the longitudinal direction of the work piece. For example, in case of a slightly wedged shape of the work piece not only in its width, but also in its length, the progression of the absolute value of the measured bearing forces represents a measure for the wedge shape of the work piece in the longitudinal direction, while the difference of the bearing forces representing a measure for the wedge shape in the width, considering any potentially existing height misalignments of the two printing rollers.

Using the sensors provided according to the invention for measuring the thickness of the work piece prior to reaching the printing gap, advantageously the frontal edge of the work piece can also be detected and by this information the work piece and/or a printing roller participating in the printing can be accelerated or decelerated, in order to ensure a precisely positioned beginning of the image on the work piece. This process is known from DE 103 33 626 A1.

When the required tolerance of the printed image allows the two printing rollers of the printing gap to be offset to a minor extent acting as off-set adjustments, so that a force acting laterally to the traveling direction of the work piece acts upon them. This can be desired in order to reliably guide the work piece along a lateral guide, for example a lateral lineal guide, and thus to ensure rectangular boards to travel precisely positioned through all printing gaps of a multi-colored printing machine.

The thickness measuring device according to the invention provided in front of the printing gap can be embodied such that distance sensors are arranged above and below the work piece and the thickness of the work piece is determined via differential calculation.

Alternatively thereto the thickness measuring device can also comprise two imaging sensors, which laterally scan the two lateral edges of the work piece and accordingly detect the profile thereof.

As another alternative the thickness measuring device can comprise a measuring calendar, which is provided with a path sensor in order to determine the thickness of the work piece. The great advantage of a measuring calendar comprises the fact that the values measured by it exactly correspond to the values that must be adjusted at the printing gap, even when the work piece has no precise wedge shape but a certain waviness, which can only be averaged by the correction of the printing gap, because the printing roller is formed cylindrically. Furthermore, the measuring calendar offers an advantage, that should not be underestimated, in the possibility not only to mount path sensors but also force sensors at the bearings, in order to perform the above-described force measurements and/or measurements of force differences before the work piece reaches the printing gap. This allows adjustment of the printing gap even prior to printing using a measurement of the difference in force.

As mentioned at the outset, the present invention is suitable particularly for multi-colored printing so that preferably several printing gaps are arranged subsequently in line. This then results in the chance to correct in a very precise manner all printing gaps based on a force measurement during the staggered printing of several colors, while the need for corrections dependent on the work piece can be performed by a single thickness measurement prior to reaching the first printing gap. The force measurement at the bearings of the individual printing rollers is therefore specific for each printing gap.

### BRIEF DESCRIPTION OF THE DRAWINGS

In the following, an exemplary embodiment of the present invention is shown and described using the attached drawings. Shown are:

FIG. 1 is a schematic top view of an exemplary embodiment of a printing device according to the invention;

FIG. 2 is a diagram of the bearing forces of the printing roller of FIG. 1;

FIG. 3 is a schematic representation of a thickness measuring device for the device shown in FIG. 1;

FIG. 4 is a schematic representation of another exemplary embodiment of a thickness measuring device.

### DETAILED DESCRIPTION OF THE PREFERRED EMBODIMENTS

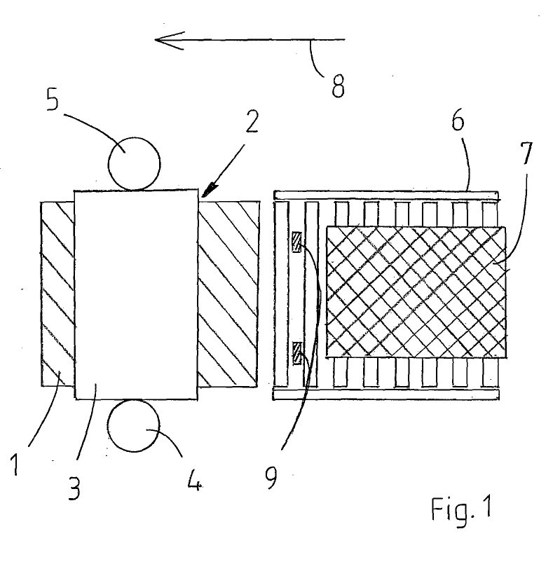

In FIG. 1, in a top view, an exemplary embodiment for a device according to the invention is shown schematically. It represents a printing machine for simple direct printing and/or a first printing station of a multi-colored printing machine, with any additional printing stations not being shown for reasons of simplification. A conveyer belt 1 travels through a printing gap 2, which is formed by a printing roller 3, embodied as an engraved cylinder, and a counter cylinder, not seen in the top view, being arranged below the conveyer belt 1. Using a left 4 and a right adjustment motor 5 the engraving cylinder 3 can be adjusted in its height, with the two adjustment motors 4 and 5 being operable independent from each other. Supported on a pre-positioned roller conveyer 6, a board-shaped work piece 7 approaches the printing gap 2 in the travel direction indicated by the arrow 8, where it is transferred to the conveyer belt 1. First it passes a thickness measuring device 9 formed from two right and left distance measuring sensors 10 each arranged above and below the work piece 7. Accordingly, the work piece 7 is measured both at its right as well as its left side, in order to detect differences in thickness for example in form of a slightly wedged shape. When such a difference in thickness is detected, the left adjustment motor 4 and the right adjustment motor 5 are adjusted respectively so that the engraved cylinder 3 is slightly off-set in reference to the counter cylinder in order to follow the wedge-shape of the work piece 7. Correspondingly, during printing the effective radius of the engraved cylinder 3 is then constant over the entire width of the work piece 7, so that no image distortions develop. Then, a lateral distortion of the work piece 7 is not to be anticipated in the printing gap 2, either.

The left and right adjustment motors 4, 5, only shown symbolically in FIG. 1, are also provided with force measuring sensors, in order to directly or indirectly measure the bearing forces acting upon the engraved cylinders during printing of the work piece 7. A difference of the left and right bearing forces means that an off-setting of the engraved cylinder 3 and the counter cylinder, caused by an off-set or other effects, cannot be exactly reproduced with regard to the thickness progression of the work piece 7 over its width and thus undesirably a difference in the effective radius of the engraved cylinder 3 occurs from the left to the right side of the work piece 7 in spite of the adjustment performed by adjustment motors 4 and 5 based on the thickness measurement device 9. This can be used to correct the trend of the connection between the values detected in the thickness measuring device 9 and the adjustment of the adjustment motors 4 and 5 for the subsequent work pieces 7.

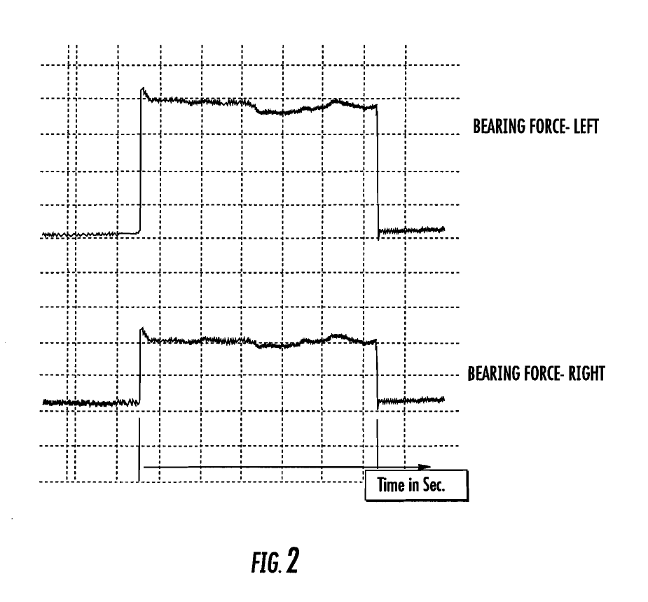

A diagram of the forces measured by the force measurement sensors allocated to the adjustment motors 4 and 5 is shown in FIG. 2. The bearing force at the left is shown at the top and the bearing force at the right is recorded at the bottom over time, with, due to the approximately rectangular shape of the forces developing, it is well discernible that in the time listed a work piece 7 has been transported through the printing gap 2. In the case shown here, the bearing force at the left is distinctly higher than the bearing force at the right, which indicates that on average the thickness progression of the work piece 7 does not harmonize with the off-set position of the engraved cylinder 3 and the counter cylinder. The higher left bearing force indicates that here the effective radius of the engraved cylinder 3 is smaller than the one on the right side.

Due to the fact that the force measuring sensors, as shown in FIG. 2, can detect the temporal progression of the left and right bearing forces, similar to the thickness measuring device 9, not only the difference in thickness of the work piece 7 is measured between its right and left side, but also its thickness profile in the traveling direction. This way an adjustment in the height of the left and the right adjustment motors 4 and 5 is possible in real time while the work piece 7 passes through the printing gap 2, based on the known thickness profile, which further improves the tolerance of the printed image.

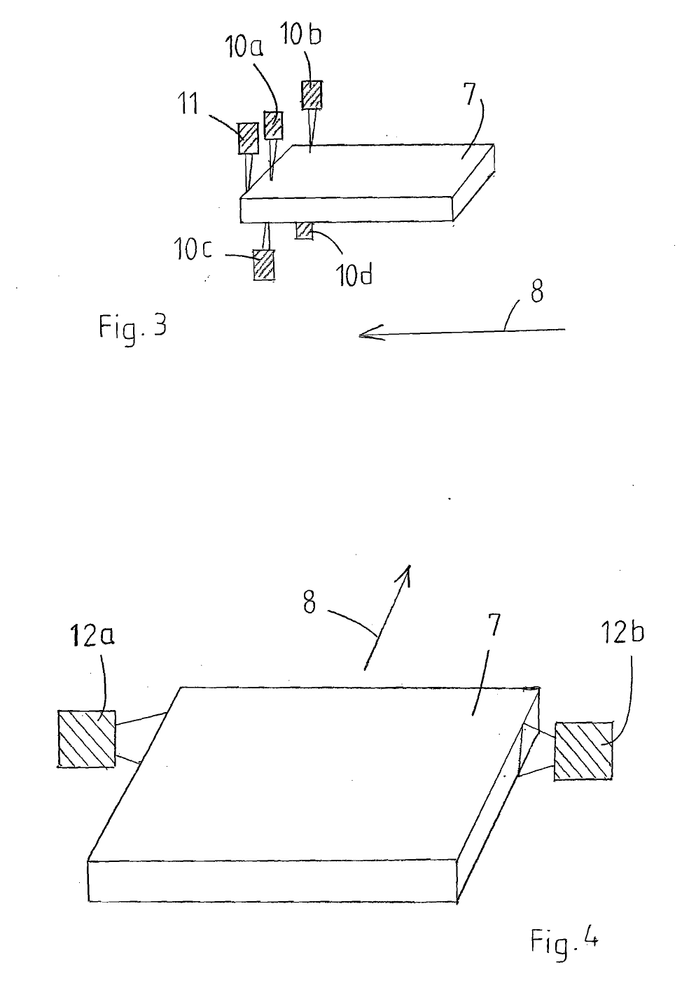

FIGS. 3 and 4 show two different exemplary embodiments for a thickness measuring device 9 of the device according to the invention. In FIG. 3 a total of four distance sensors 10 are provided for thickness measurement, namely seen above the work piece in the traveling direction 8 at the left side 10a and on the right side 10b, as well as below the work piece on the left side 10c and on the right side 10d. By comparing the difference in each of the left two distance sensors 10a and 10c and/or the two right distance sensors 10b and 10d, the thickness of the work piece 7 is measured at the right and the left.

In FIG. 3 a frontal edge sensor 11 is additionally discernible, which sends a signal as soon as the frontal edge 7 of the work piece passes it. Using this signal, as known per se, the printed image can be triggered or, if necessary, the engraved cylinder 3 or a rubber web cylinder arranged between the engraved cylinder and the work piece 7 can be accelerated or decelerated such that the beginning of the printed image coincides with the frontal edge of the work piece 7 and no frame remains.

FIG. 4 shows another embodiment of a thickness measuring arrangement: seen in the traveling direction 8, laterally next to the work piece, two CCD cameras 12 are arranged, with a left CCD camera 12a scanning the left lateral edge of the work piece 7, while a right CCD camera 12b senses the right lateral edge of the work piece 7. Using the pixels collected by the CCD cameras 12 and their grayscale values, the thickness of the work piece 7 passing the respective CCD cameras 12 can be determined.

1. A method for printing board-shaped work pieces in a printing gap, comprising:
forming the printing gap with two printing rollers that are adjustable in reference to each other in their respective distance;
transporting a board-shaped work piece to the printing gap on a transport device;
printing the board-shaped work piece while it is passing through the printing gap;
prior to or during transporting of the board-shaped work piece to the printing gap, measuring a thickness of each of the work pieces; and
adjusting the printing gap prior to the printing process via parallel or off-set adjusting of a distance between the two printing rollers in reference to each other according to the measured thickness of the work piece.

2. A method according to claim 1, wherein the thickness of the work piece is measured at least at two measuring points, with a connecting line of the two measuring points essentially extending parallel to axes of the printing rollers.

3. A method according to claim 1, wherein the measurement of the thickness of the work pieces occurs in a transport direction over an entire length of the work piece so that a thickness profile is measured, and the printing gap is adjusted in real time based on the measured thickness profile when the work piece passes through the printing rollers.

4. A method according to claim 1, further comprising measuring bearing forces acting on bearings of the printing rollers during printing, and adjusting the distance of the two printing rollers in reference to each other for a difference of the measured bearing forces until the difference of the measured bearing forces approaches zero or is approximately equivalent to a desired offset value.

5. A method according to claim 4, further comprising using the bearing forces measured during printing as correction values for adjustment of the printing gap for work pieces to be subsequently printed work according to the measured thickness of the work pieces to be subsequently printed.

6. A method according to claim 5, wherein a change in the distance between the two printing rollers in reference to each other based upon the bearing forces measured or as a correction value to the adjustment of the printing gap occurs based on differential values of the bearing forces determined in temporal intervals, in order to yield an overall correcting trend.

7. A method according to claim 1, further comprising detecting a frontal edge of the work piece simultaneously when measuring the thickness of the work pieces, and at least one accelerating or decelerating at least one of the work piece and/or the image printing roller in order to ensure a precisely positioned beginning of the image on the work piece.

8. A method according to claim 1, wherein the two printing rollers of the printing gap are offset in reference to each other as off-set adjustments so that a force laterally to the transport direction acts upon the work pieces in order to guide them along a lateral guide.

9. A device for printing images on board-shaped work pieces, comprising:
two printing rollers (3) that are adjustably spaced at a distance apart from one another which form a printing gap (2) for printing a board-shaped work piece (7);
a transportation device (1) for transporting the work piece (7) to the printing gap (2);
a thickness measurement device (9) arranged in front of or at the transport device (1), upstream from the printing gap (2), for detecting a thickness of the transported work pieces (7); and
adjustment motors (4, 5) arranged at both sides of at least one of the two printing rollers (3) forming the printing gap (2) in an area of the bearings for a unilateral and/or bilateral adjustment of the distance of the two printing rollers (3) in reference to each other;
the thickness measurement device (9) and the adjustment motors (4, 5) are connected to a control unit, which is programmed such that the printing gap (2) is adjusted according to a measured thickness of the work piece (7), prior to the printing process, parallel or offset via a unilateral or bilateral adjustment of the adjustment motors (4, 5).

10. A device according to claim 9, wherein the thickness measuring device (9) comprises distance sensors (10) arranged above and below the work piece (7).

11. A device according to claim 9, wherein the thickness measuring device (9) comprises at least two imaging sensors (12) that scan lateral edges of the work piece (7).

12. A device according to claim 9, wherein the thickness measuring device (9) comprises a measuring calendar with travel and/or force measuring sensors.

13. A device according to claim 9, wherein the transport device (1) comprises a conveyer belt guided through the printing gap (2).

14. A device according to claim 9, wherein force measuring sensors for detecting bearing forces are provided at least at bearings of one of the printing rollers (3), with the force measuring sensors being connected to the control unit and with the control unit being programmed such that the distance between the two printing rollers (3) in reference to each other are changed in an off-setting manner, when a difference of the bearing forces is detected by the force sensors, until the difference of the bearing forces approaches approximately zero or is approximately equal to a desired offset value.

15. A device according to claim 14, wherein a measured difference of the bearing forces acts as a correcting value for adjustment of the printing gap (2) for subsequent work pieces (7) to be printed according to the measured thickness of the work piece (7).

16. A device according to claim 9, wherein a plurality of the printing gaps (2) are arranged sequentially in a line.
